(19) United States
(12) Patent Application Publication
(10) Pub. No.: US 2013/0268319 A1
(43) Pub. Date: Oct. 10, 2013

(54) METHOD AND APPARATUS FOR PRICE OPTIMIZATION IN AN ONLINE CONSULTATION SYSTEM

(71) Applicant: PEARL.COM LLC, San Francisco, CA (US)

(72) Inventor: Giulio Palombo, San Francisco, CA (US)

(73) Assignee: PEARL.COM LLC, San Francisco, CA (US)

(21) Appl. No.: 13/741,287

(22) Filed: Jan. 14, 2013

Related U.S. Application Data
(63) Continuation-in-part of application No. 13/439,743, filed on Apr. 4, 2012.

(51) Int. Cl. G06Q 30/02

(52) U.S. Cl. CPC G06Q 30/0202
USPC 705/7.31

(57) ABSTRACT

Embodiments of the present invention further provide systems and methods for optimizing prices for paid question and answers in an online consultation website, where user attributes are defined and segmented based on parameters influencing the price. At least a high price and a low price test path are created for each segment, and revenue generated for each test path is measured and the highest revenue path is selected as the optimized path and the price corresponding to highest revenue path as the optimized price for the online consultation system.

### RELATED APPLICATIONS

The present application is a continuation in part of U.S. patent application Ser. No. 13/493,743 filed on Apr. 4, 2012, entitled “Method and Apparatus for Determining Pricing Options in a Consultation System.”

### FIELD OF INVENTION

The present application generally relates to the field of computer technology and, in specific exemplary embodiments, to methods and systems for optimizing prices for receiving answers to user asked questions an online consultation system may go unanswered.

### BACKGROUND

The Internet has become the repository for all kinds of information and the first go to source for many people. The abundance of information available online has made finding accurate and reliable information difficult. Search engines help find information based on the content of the document. However, search engines cannot provide any guarantee on the reliability of the information. A paid online consultation system allows users to submit questions on specific topics, for a fee and receive tailored answers from professionals that have been verified to have a required level of competency in a particular topic. For the professionals, the online consultation system provides a source of income, and a means to connect with and satisfy the needs of clients that may otherwise not have any access to due to geographical or temporal distance. For the users, the online consultation system provides a source for reliable, customized and accurate information that is readily available to them at any time. However, when submitting a question to the online consultation system, users tend to underestimate the value of a service. Similarly, professionals will tend to overestimate the value of their service. If the users were allowed to select any price they wish to pay, many questions will go unanswered because the professionals will not be willing to provide their services at the price offered. Furthermore, in most cases, users lack the necessary information to set a true price for the answer they are seeking. The only fact a user is certain of is how much he or she is willing to pay for an answer. In an efficient question and answer consultation system, users can receive fast responses to their submitted questions and professionals compete to quickly answer users' questions because they are satisfied with the fee they are receiving for their service. The prerequisite for an efficient market place for the users and professionals to interact is an optimized price.

### BRIEF DESCRIPTION OF DRAWINGS

The appended drawings are merely used to illustrate exemplary embodiments of the present invention and cannot be considered as limiting its scope.

FIG. 1 is a diagram of an exemplary environment in which embodiments of the present invention may be practiced.

FIG. 2 is a block diagram of an exemplary consultation system.

FIG. 3 is a block diagram of an exemplary web server.

FIG. 4 is a block diagram of an exemplary channel management engine.

FIG. 5 is an exemplary flow chart of the price optimization process.

FIG. 6 shows an exemplary flowchart of the method of selecting a new price set.

FIG. 7 shows a simplified block diagram of a digital device within which a set of instructions, for causing the machine to perform any one or more of the methodologies discussed herein, may be executed.

### DETAILED DESCRIPTION

The description that follows includes illustrative systems, methods, techniques, instruction sequences, and computing machine program products that embody the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on quality control of professionals, the embodiments are given merely for clarity and disclosure. Alternative embodiments may employ other systems and methods and are considered as being within the scope of the present invention.

Embodiments of the present invention provide systems and methods for optimizing the price for answers to questions submitted by users in an online consultation system. In exemplary embodiments of the present invention, a system and method are taught that continuous optimization of the prices for answers to user submitted questions where the price optimization is based on various parameters affecting the price as well the effect of the price changes on revenue.

In other exemplary embodiments of the present invention price optimization may be continuously updated based on new revenue data.

In order to clarify the application of the present invention, a fee for service online consultation system is used as an illustrative example. It would be apparent to one of skill in the art that the teachings of the present invention are not limited to the examples used herein and the systems and methods of the present invention have broader applications.

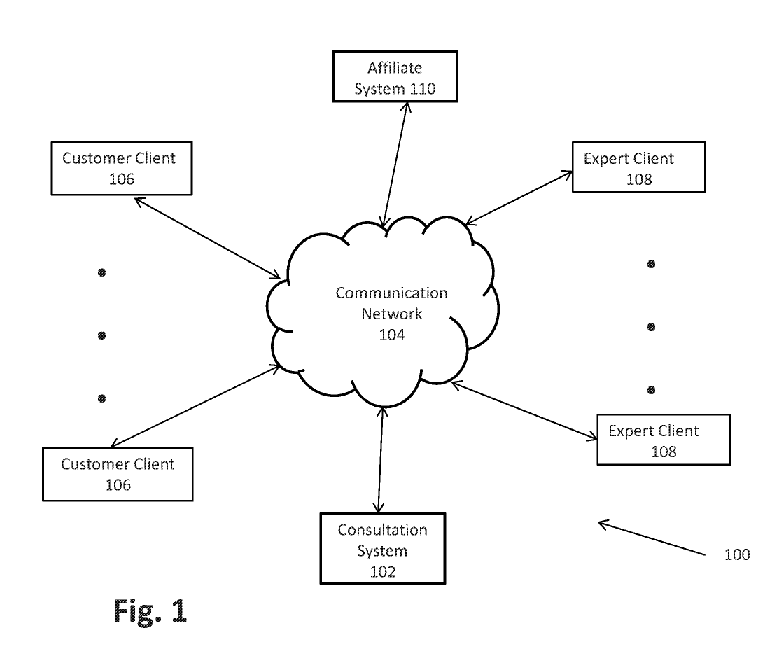

FIG. 1 shows an exemplary environment 100 of an online consultation website and system in which embodiments of the present invention may be practiced. The exemplary environment 100 comprises a consultation system 102 coupled via a communications network 104 to one or more user clients 106 and professional clients 108. The communication network 104 may comprise one or more local area networks or wide area networks such as, for example, the Internet and telephone systems.

In exemplary embodiments, the consultation system 102 provides a forum where users may post or pose questions for which professionals may provide answers. The consultation system 102 may provide the forum via a website. In some embodiments, at least portions of the forum (e.g., asking of questions or receiving of responses) may occur via the website, mobile phone, other websites, text messaging, telephone, video, VoIP, or other computer software applications. Because the consultation system 102 is network based e.g., Internet, the users using the consultation system 102 and professionals providing answers may be geographically or temporally dispersed (e.g., may be located anywhere in the world in different time zones). As a result a professional may provide answers to a user thousands of miles away. Additionally, the consultation system 102 allows a large number of users and professionals to exchange information at the same time and at any time.

By using embodiments of the present invention, a user posting a question may easily obtain an answer specific to facts the user has provided. Accordingly, one or more of the methodologies discussed herein may obviate a need for additional searching for answers, which may have the technical effect of reducing computing resources used by one or more devices within the system. Examples of such computing resources include, without limitation, processor cycles, network traffic, memory usage, storage space, and power consumption. In addition, the system allows the users to access reliable, customized information responsive to their issue without excessive searching of the Internet.

In various embodiments, a user may pose a question and one or more professionals may provide answers. In various embodiments, the question may be matched with a category of professionals, more specific set of professionals, or even individual professionals, sometimes on a rotating basis by user selection, a keyword based algorithm, a quality based algorithm (or score or rating), or other sorting mechanism that may include considerations such as, for example, likely location or time zone. A back-and-forth communication can occur.

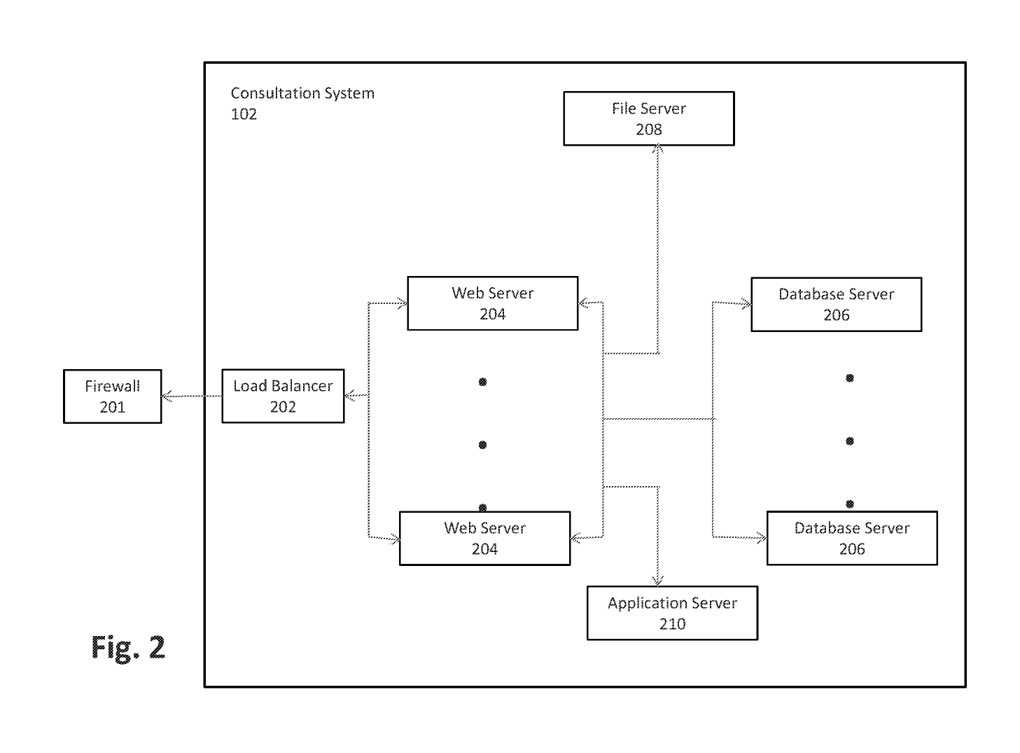

The user may accept an answer provided by one or more of the professionals. In an alternative embodiment, the user may be deemed to have accepted the answer if the user does not reject it. By accepting the answer, the user validates the professional's answer which, in turn, may boost a score or rating associated with the professional. The user may also pay the professional for any accepted answers and may add a bonus. The user may also leave positive, neutral or negative feedback regarding the professional. More details regarding the consultation system 102 and its example functions will be discussed in connection with FIG. 2 below.

The exemplary user client 106 is a device associated with a user accessing the consultation system 102 (e.g., via a website, telephone number, text message identifier, or other contact means associated with the consultation system 102). The user may comprise any individual who has a question or is interested in finding answers to previously asked questions. The user client 106 comprises a computing device (e.g., laptop, PDA, cellular phone) which has communication network access ability. For example, the user client 106 may be a desktop computer initiating a browser for access to information on the communication network 104. The user client 106 may also be associated with other devices for communication such as a telephone.

In exemplary embodiments, the professional client 108 is a device associated with a professional. The professional, by definition, may be any person that has, or entity whose members have, knowledge and appropriate qualifications relating to a particular subject matter. Some examples of professional subject matters include health (e.g., dental), medical (e.g., eye or pediatrics), legal (e.g., employment, intellectual property, or personal injury law), car, tax, computer, electronics, parenting, relationships, and so forth. Almost any subject matter that may be of interest to a user for which a professional has knowledge and appropriate qualifications may be contemplated. The professional may, but does not necessarily need to, have a license, certification or degree in a particular subject matter. For example, a car professional may have practical experience working the past 20 years at a car repair shop. In some embodiments, the professional may be a user (e.g., the professional posts a question).

The professional client 108 may comprise a computing device (e.g., laptop, PDA, cellular phone) which has communication network access ability. For example, the professional client 108 may be a desktop computer initiating a browser to exchange information via the communication network 104 with the consultation system 102. The professional client 108 may also be associated with other devices for communication such as a telephone.

In accordance with one embodiment, an affiliate system 110 may be provided in the exemplary environment 100. The affiliate system 110 may comprise an affiliate website or other portal which may include some of the components of the consultation system 102 or direct their users to the consultation system 102. For example, the affiliate system 110 may provide a website for a car group. A link or question box may be provided on the affiliate website to allow members of the car group to ask questions. The environment 100 of FIG. 1 is exemplary. Alternative embodiments may comprise any number of consultation systems 102, user clients 106, professional clients 108, and affiliate systems 110 coupled together via any type of one or more communication networks 104, and still be within the scope of exemplary embodiments of the present invention. For example, while only one consultation system 102 is shown in the environment 100, alternative embodiments may comprise more than one consultation system 102. For instance, the consultation systems 102 may be regionally established.

Referring now to FIG. 2, the consultation system 102 is shown in more detail. In exemplary embodiments, the consultation system 102 may comprise a load balancer 202 which distributes work between two or more web servers 204 in order to optimize resource utilization and minimize response time. In some embodiments, a firewall 201 may be provided prior to the load balancer 202.

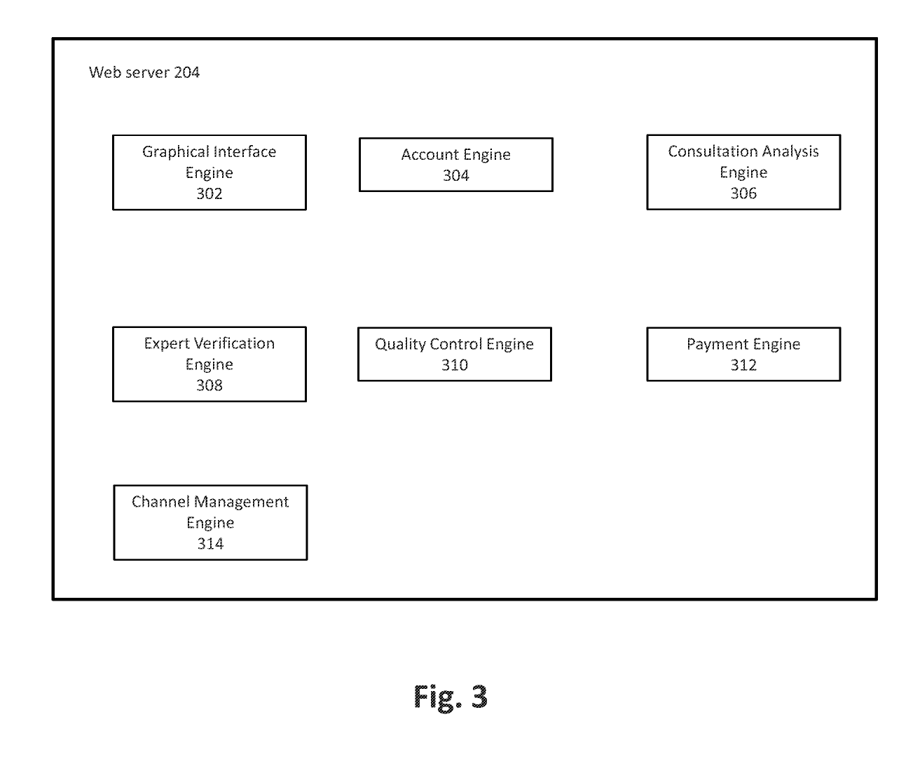

In exemplary embodiments, the web servers 204 are responsible for accepting communications from the user client 106 (e.g., request or question) and professional client 108 (e.g., response) and serving the response including data content. In some instances, the request and response may be in HTTP or HTTPS which will result in documents and linked objects (e.g., images) being provided to the user and professional clients 106 and 108. The communications may include, for example, questions from the users, answers from the professionals, acceptance from the user, payment information, account update information, videos, documents, photographs and voice. The web server 204 will be discussed in more detail in connection with FIG. 3.

Information used by the web server 204 to generate responses may be obtained from one or more database servers 206 and a file server 208. The exemplary database servers 206 store data or are coupled with data repositories storing data used by the consultation system 102. Examples of data include user information (e.g., username, e-mail address, credit card or other payment information), professional information (e.g., name, licenses, certifications, education and work history), previously asked questions and corresponding answers, and transaction information (e.g., payment, accepts, etc.). Essentially any data may be stored in, or accessed by, the database servers 206 including every user and professional interaction with the consultation system 102. Examples of interactions include how many questions the user has asked, which professionals provided answers to the questions, and whether the user accepted the answers and paid the professional.

Content on the database servers 206 (or accessed by the database servers 206) may be organized into tables, and the tables may be linked together. For example, there may be one table for every question that has been previously asked, another table for posts (e.g., answers) to each question, and other tables for users and professionals. In one example of the present invention, over 430 tables or spreadsheets are linked together.

In some embodiments, the database servers 206 may include logic to access the data stored in the tables. The logic may comprise a plurality of queries (e.g., thousands of queries) that are pre-written to access the data.

It should be noted that the functions of the database server 206 may be embodied within the web server 204. For example, the database servers 206 may be replaced by database storage devices or repositories located at the web servers 204. Therefore, any reference to the database server 206 and database storage device are interchangeable. Alternatively, some or all of the query logic may be embodied within the web server 204.

In exemplary embodiments, a plurality of database servers 206 is provided. The plurality of database servers 206 may share data and thus be identical (or close to being identical). By having identical database servers 206, load balancing and database backup may be provided.

The file server 208 stores or accesses files such as, for example, pictures, videos, voice files, PDF documents, Word documents, and PowerPoint presentations. When a particular file is requested or required in order to generate a response, the web server 204 may query the file server 208 for the file. Alternatively, the files may be stored at the database server 206 or other database storage devices, for example.

An application server 210 may also be provided in the consultation system 102. The application server 210 may provide applications and functions that are centralized to the consultation system 102. For example, the application server 210 may perform credit card processing with a bank that is coupled to the consultation system 102 via a network (e.g., the communication network 104).

It should be appreciated that in alternative embodiments, the consultation system 102 may include fewer or more components than shown in FIG. 2. For example, the consultation system 102 may comprise any number of web servers 204, database servers 206, file server 208, and application server 210. In another example, the file server 208 and application server 210 may be removed from the consultation system 102 and their functions performed by other servers in the consultation system 102. It will also be appreciated that the various servers may be embodied within each other and/or the consultation system 102 may be embodied within a single server. For example, the database server 206 may be embodied, as a storage device within the web server 204. It is also noted that the various servers of the consultation system 102 may be geographically dispersed within the exemplary environment 100.

Referring now to FIG. 3, one of the exemplary web servers 204 is shown in more detail. As discussed, the web servers 204 share in the workload in order to provide optimized performance. As such, each of the web servers 204 will include similar engines and modules. In the exemplary embodiment of FIG. 3, the web server 204 comprises a graphical interface engine 302, an accounts engine 304, a consultation analysis engine 306, a professional verification engine 308, a quality control engine 310, a payment engine 312, and a channel management engine 314 communicatively coupled together.

The exemplary graphical interface engine 302 generates graphical representations provided via the web page. In exemplary embodiments, the graphical interface engine 302 builds a page made up of HTML, Javascript, CSS, sound, video, images, and other multimedia) that is presented to the user client 106 or professional client 108. The page comprises static text (e.g., “Welcome to JustAnswer.”) and dynamic data (e.g., “Hello, hulagirl. You joined 3 months ago; have asked 17 questions; have accepted 12 answers.”). The dynamic data may be obtained, at least in part, from the database servers 206. In exemplary embodiments, the dynamic data may be retrieved using querying logic associated with the web server 204, the database server 206, or a combination of both, as discussed above.

The exemplary accounts engine 304 sets up, and maintains user accounts with the consultation system 102. Initially, the accounts engine 304 may provide a registration page via the graphical interface engine 302 for an individual (e.g., a user or professional) to fill out. The information collected via the registration page may be stored in the database server 206. Examples of information include user name, e-mail address, and billing and payment information. With respect to professionals, the accounts engine may also collect information regarding the identity of the professional, information on credentials (e.g., license and certification numbers, degrees including university attended and years of attendance, employment history), and other data relating to the professional and the professional's application. Accounts for users may be automatically established and activated based on certain actions taken by the user, such as asking a question, agreeing to the terms of the consultation system, or providing payment. However, professionals, in accordance with exemplary embodiments, proceed through an acceptance and verification process. If accepted, a professional account may then be established and activated by the accounts engine 304. The verification process will be discussed in more detail below.

The consultation analysis engine 306 manages answers in response to questions which have been posted to the consultation system 102. In exemplary embodiments, the consultation analysis engine 306 will receive questions along with indications of a category or subject matter each question is directed to from users. In various embodiments, a user may utilize a question page to enter a question which the user wants a professional to answer. As further described below, in many cases a user may initially find the consultation website after having first having entered a query in a search engine. Having found the online consultation site, the user may enter its question in the field for entering the question, including providing relevant information relating to the question (e.g. make and model of a car), as well as a selection box for selecting a subject matter professional under which the question should be posted to. In exemplary embodiments, other pages may be presented to the user before or after the question is submitted to professionals, to obtain further data from or provide data to the user. In alternative embodiments, a “question details” page may be presented to users to solicit important information that could help the professional formulate a better answer to the user's question (e.g. make and model of a car in the car category, breed and age of a pet in the veterinary category, etc.). The question is also recorded into a corresponding table in the database server 206 (e.g., in a question table) and the user name of the user may also be entered into a corresponding table (e.g., user table). In some instances, the question may be outputted back to the user so that the user may confirm the question or edit the question if needed.

The user may also provide an amount that the user is willing to pay for an accepted answer, in some embodiments, as an amount selected by the user from different options offered to the user.

Once the question is posted on the consultation system 102, professionals may provide answers in response to the question. The questions may be posted to a general or subject matter specific question list of recent questions that have been posted by users, a more specific group of professionals, or certain professional one-at-a-time. In various embodiments, the question list may be sorted by certain types of information such as time of posting, the amount the user is willing to pay (e.g., value), the user's history of accepting previous answers, information regarding the subject matter of the question, or whether replies have been previously posted. Professionals may periodically review the question list or other communications alerting them to questions to determine if there are any questions that the professional would like to answer. The professional may base their determination, in part, on the complexity of the question, their expertise, the amount the user is willing to pay for an answer, or the user's history of accepting previous answer, and whether the question is complete or missing details. Any of these factors may contribute to the reason why a question may go unanswered and directly or indirectly affect the price of an answer.

In various embodiments, the user is able to place a deposit and name a price for an answer when posting the question or place the deposit after a professional has answered.

Should the professional decide to answer a question or request further information, an indication is provided to the user that there is an answer being offered or a request for further information, sometimes in the form of the answer or the request itself. The indication may also comprise an e-mail, text message, or pop-up notification to the user. In some cases, the user may place a deposit (e.g., the amount agreed upon to be paid if an answer is accepted) after being given the opportunity to view a profile of the professional offering the answer or a portion of the answer.

The answer is provided to the user. The answer may be displayed on a web page (e.g., an answer page), provided via a chat session, provided via a voice or text message, provided via video, provided by a software application, provided by other social media means (e.g., social networking sites where the user has a personal profile or page), or provided by telephone, mobile phone, or VoIP. Upon review of answers posted in response to a question, the user decides if any of the answers are acceptable to the user. The user may accept one or more answers that are posted. In exemplary embodiments, the user will pay the professional posting any accepted answers. If a particular answer is exceptional, in exemplary embodiments, the user may also provide a bonus to the professional providing the exceptional answer. When the user accepts an answer, monies from the deposits may also be paid to a host of the question and answers platform (e.g., host of the consultation system 102).

In various embodiments, different pricing options may be used for determining what a user may pay for receiving an answer to a question and what a professional may be paid for providing an answer. In one embodiment, the pricing options may vary for each category or subcategory based on a variety of factors related to the questions and the users submitting the questions. These factors may include, for example, question length, time of day, day of week, location, or the ability of a user to pay, as well as the user geographic location, type of browser used, whether the user is a return customer, etc. Additionally, discounts may be offered (e.g., two for one, ask one question get second for 50% off, free for pro bono users). In other embodiments, pricing may be selected and paid for by third-parties (e.g. employers of the users). In yet other embodiments, a user may subscribe to a subscription plan (e.g., unlimited questions each month for a particular fee or up to 10 questions each month for another fee). In other embodiments, a user or professional may be allowed to adjust the price prior to, during, or after the interaction between the user and the professional.

In alternative embodiments of the present invention, a set of suggested prices (e.g. high, medium and low price) may be presented to the user based various question parameters and user attributes affecting the price, including the category of the question, the time of day, time of day group, the day within the week, the day of week group (e.g. weekend vs. weekday), the type of Internet browser the user uses, the geographical location of the user (e.g. the country, the US state, US state group, region). Question related factors such as the category of the question, the length of a question and keywords or topics identified in the submitted question may influence the suggested price set presented to the user. An exemplary price set may include a high, a medium and a low price for a submitted question. Using one of the options high, medium or low prices from the suggested price set, the user will offer a particular price he or she is willing to pay for a particular answer, with the understanding that the higher the offered price, the more likely it is that the user will receive a quick answer that is satisfactory and complete.

The professionals have an incentive to answer the questions that require the least amount of work and the highest price. Users have an incentive to pay the lowest price possible to receive a satisfactory answer to their question. In order to achieve this goal, users may start by offering a low price and gradually increase the price they are willing to pay for an answer. Alternatively, the users and professionals may negotiate a price. However, such alternatives have the disadvantage of introducing delays in receiving an answer to the user submitted question.

In alternative embodiments of the present invention, price sets suggested by the online consultation system are optimized based on the impact on the revenue. Such price optimization allows for the suggested price set to become a closer reflection of the true market price for a given answer taking into consideration the various user attributes and question parameters. In the exemplary systems and methods of present invention the optimized prices are periodically or continuously updated with new data. Therefore, the users will be offered price sets that are most likely to get them fast and accurate answers to their posted questions, and professionals are more likely to answer a question because the offered price that is more representative of the true market price commensurate with the effort required to provide a given answer.

Acceptance and non-acceptance actions are tracked by the consultation analysis engine 306. For example, every user's accept-to-question ratio may be tracked and may be published to professionals. Thus, if the ratio is low, professionals may not answer the user's questions in the future. Furthermore, the user's question posting privileges may be suspended or the user may be removed from the consultation system 102 if the ratio is low or falls below a ratio threshold. The tracked acceptance and non-acceptance information is stored to the database server 206, and may be used to evaluate the quality of the professionals as is discussed herein.

The user may also provide comments and feedback after viewing or accepting one or more answers. The feedback may be provided as, for example, a written comment, star rating, numerical scale rating, or any other form of rating. The feedback is stored to the database server 206, and may be used in the quality control processing. User satisfaction surveys may also be sent to collect data on the user's experience with the site, the professional, or the answer the user received.

According to some embodiments, if a user submitted question has been previously answered, a query of the database server 206 may be performed. The answers to previously asked questions may be stored in corresponding answer tables in the database server 206. These embodiments may occur when, for example, a user searches (e.g., using Google) for previous questions and answers. Multiple instances of access to the same questions and/or answers may be provided via a cache. Some or all users may also be allowed to search some or all previous questions or answers via a search tool on the website, or some or all previous questions or answers may be displayed to users at the discretion of the host, affiliate, or professional of the consultation system.

The exemplary professional verification engine 308 performs verification and acceptance of professionals. In accordance with exemplary embodiments, the professional verification engine 308 verifies information provided by the potential professionals (or professionals) or receives verification data used to verify the professionals' identities or credentials. The verification may occur prior to allowing the professional to join the consultation system 102. Alternatively, the verification may occur any time after the professional has joined the consultation system 102. More than one verification may be performed for each professional, by requirement or by the professional's choice.

In exemplary embodiments, the quality control engine 310 evaluates professionals in order to promote the high quality of professionals in the consultation system 102. The evaluation may comprise scoring or ranking professionals based on various elements. For example, the quality control engine 310 may access and review feedback associated with each professional and score each professional accordingly. The quality control engine 310 may also review other factors which may increase or decrease a professional's score or ranking. The exemplary payment engine 312 manages pricing options and the payment of fees. In accordance with exemplary embodiments, users pay professionals for accepted answers to their questions, for example, by way of payments per questions, payments per answers, payments per time frame, or payments on a subscription basis. It should be apparent to one of skill in the art that although the application of the teachings of the present invention is illustrated using a pay per question payment and pricing model, in alternative embodiments of the present invention, optimized pricing system and methods may be applied to subscription based access and other types of pricing models.

In some instances, the user may provide a deposit in order to view answers prior to accepting the answers. The payment engine 312 may maintain a record of all these transactions. Additionally, the payment engine 312 may work with the application server 210, if provided, to process payments (e.g., credit card processing, PayPal processing).

The exemplary channel management engine 314 manages the creation of new channels in the consultation system 102. A new channel may comprise a new category or a new affiliate relationship on the consultation system 102. In some embodiments, the new category may be placed on a test site of the consultation system 102. However, questions may be posted to a main site of the consultation system 102 so that professionals on the main site may also provide responses to the questions. Should the new category prove to be successful, the new category may then be moved to a main site of the consultation system 102. The new affiliate relationship results in the affiliate system 110 being linked to the consultation system 102.

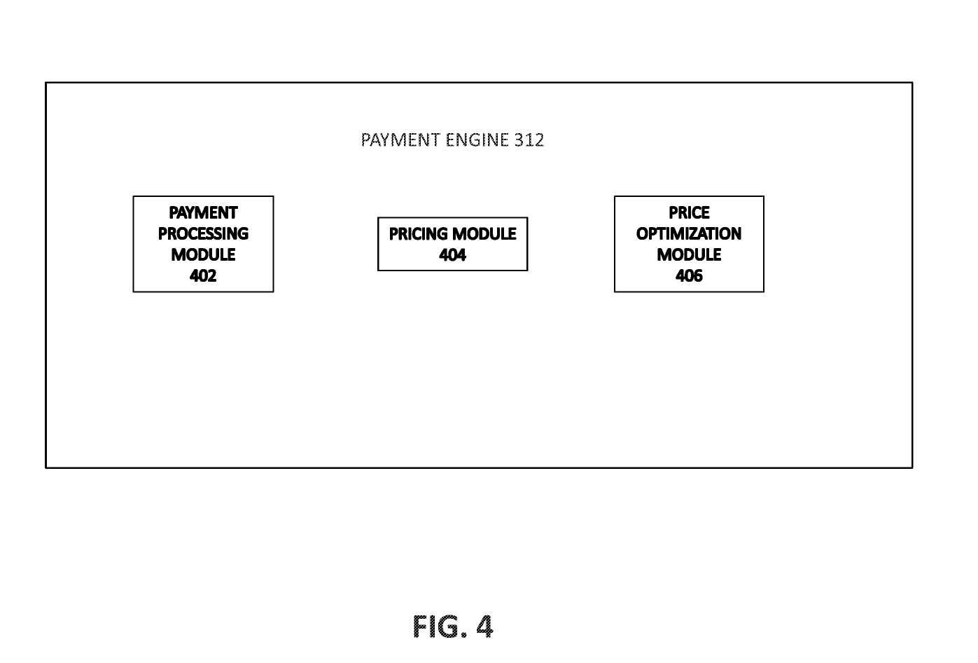

FIG. 4 is a block diagram of the payment engine 312. In the exemplary embodiment of the present invention, the payment engine 312 manages financial transaction occurring on the online consultation system 102 including payment processing, pricing etc. The exemplary payment engine 312 of the present invention includes a payment processing module 402, a pricing module 404 and a price optimization module 406.

The payment processing module 402 includes tools to process and maintain a record of user payments, and tools to process payouts to professionals and affiliates.

The pricing module 404 calculates price sets to users for the answers they are seeking based on the various question related factors affecting price as well user attributes that may influence the price. The question related factors that affect the price include question category and subcategory, question length, time of day the question is being submitted, day of week, or the ability of a user to pay, as well as the user geographic location, type of browser used, whether the user is a return customer, etc.

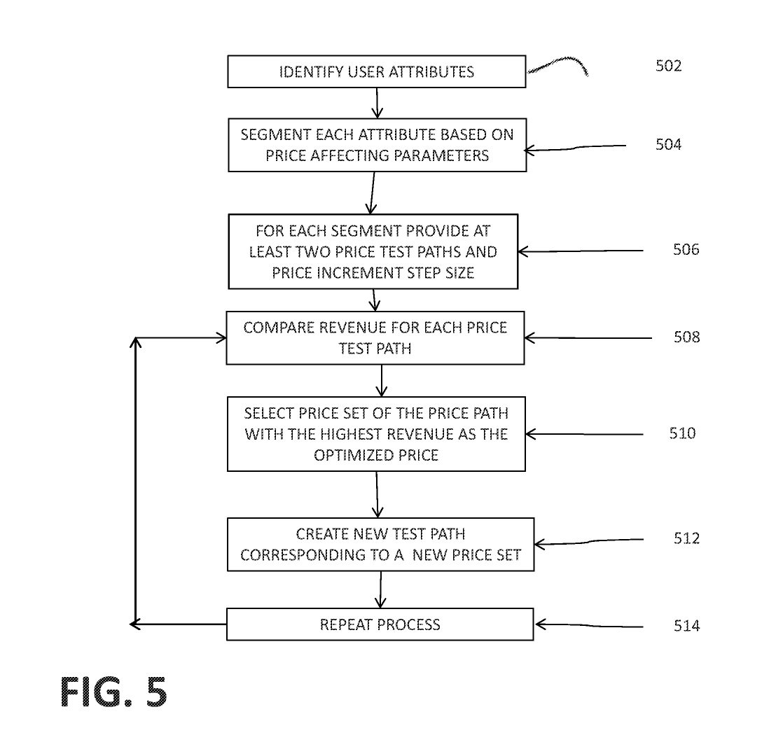

In exemplary embodiments of the present invention, the price optimization module 406 performs the necessary processing to optimize price sets for the various questions asked. The price optimization module 406 is further described below in FIG. 5. In alternative embodiments of the present invention, the price optimization module 406 may be incorporated into the pricing module 404. In yet another embodiment of the present invention, the price optimization module 406 may be incorporated in the consultation analysis engine 306 or the channel management engine 314.

FIG. 5 shows an exemplary flow chart of the price optimization process. The exemplary consultation system 102 of the present invention may include hundreds of categories and subcategories of topics, where in each category and subcategory, many professionals whose credentials as experts in the relevant subject matter have been verified and are available to answer user questions. A successful consultation system 102 may have thousands of users submit questions in each of the many topic categories, generating a large quantity of very relevant and specific content.

Returning now to FIG. 5, in operation 502, the user attributes that affect the price of an answer are identified. As previously described, the user related attributes that influence the price include user's geographic location, including the country, the state and the city or region, the type of browser the user uses, whether the user is a return customer, the user's accept rate, the time of day the question was asked, the day of the week the question is asked, the day of the week group (e.g. weekday vs. weekend). Depending on the subject matter of the question, each of the above user attributes may have more or less influence on the price of an answer. For example, questions in the medical category that are submitted after midnight on a weekday may be priced higher than a question presented at the same time in the art appraisal category. There may be a presumption of urgency with the medical question that may not be present with the art appraisal category. In alternative embodiments of the present invention, the content of the question will also influence the price of an answer.

In operation 504, each user attribute is divided up into constituent segments. In exemplary embodiments of the present invention, the type of browsers/computers users use may be divided up into: “Internet Explorer”, “Chrome,” “Mozilla FireFox”, “Apple's Safari.” The day of the week may be segmented into Monday, Tuesday, Wednesday, Thursday, Friday, Saturday and Sunday. Same type of segmentation is applied to every user attribute that influences the answer price.

In operation 506, for each segment at least two price test paths are created. In exemplary embodiments of the present invention, each price test path may include a price set including three price components which may be presented to the user as a low, medium and high price options. In each test path, the user may select any of the three price options to offer as compensation for her answer. However, users directed to different test paths will have different price components to choose from.

In yet another example, a price slider may be presented to the user for each price test path. The range of prices corresponding to the various slider positions will correspond to a low, medium and high price option.

A given set of user attributes and question parameters will correspond to a given segment or cell and will have at least two different price paths associated with it. For example “Monday, Chrome browser, state of California, etc.” will correspond to one segment, and for that segment, each test path will present three price options a user can select, a low price, a medium price and a high price option. The limiting factor as to how granular the segment can be is the size of the available data set. If the online consultation website 102 has enough paying users and generates enough samples in a given time period, the revenue differential between two test paths can be considered statistically significant.

In operation 506, price increments or step sizes are selected. A price increment is used in calculating the components of the next price to be used in the optimization process. In exemplary embodiment of the present invention, the price set including the high, medium and low prices, each of the component prices may have a different price increment. Alternatively, all three price components may be incremented by the same amount.

In operation 508, the revenue from each price test path is compared to each other. It should be apparent to one of skill in the art that the sample space corresponding to each price test path should be large enough to allow for meaningful conclusions to be drawn from observing any revenue differential between the test paths. In alternative embodiments of the present invention, as more data is collected, the size of the segment under testing may be reduced and each segment may be divided up into smaller subsets. For example, the segment corresponding to weekday and weekend may be further segmented into individual days from Monday through Sunday. With the right amount of data, this level of granularity would allow optimization of prices for each day of the week rather than optimizing at the level of weekends and weekdays only.

In operation 510, the price test path with the highest revenue is selected. In alternative embodiments of the present invention, revenue per hit may be measured instead of revenue. Revenue per hit may be defined as the amount of revenue generated for each question submitted. An alternative definition may be based on the revenue generated for each answer paid for. In the example of the online consultation system 102, the number of users visiting the website is assumed to be constant for the test period. In that case, the revenue per hit or revenue calculations should yield similar results. It should be apparent to one of skill in the art that for the results of the testing to be statistically significant, a significance level for the results must be defined based on the sample size. In the present exemplary embodiment, the level of revenue increase corresponding to a price test path is adjusted based on the sample size. For example, if the sample size is under 20,000 hits or user submission of questions, or user payment for an answer, then the change in the revenue must be greater than 4% to be considered statistically significant. Similarly, for a sample size of 150,000 hits a 2% change would be considered significant.

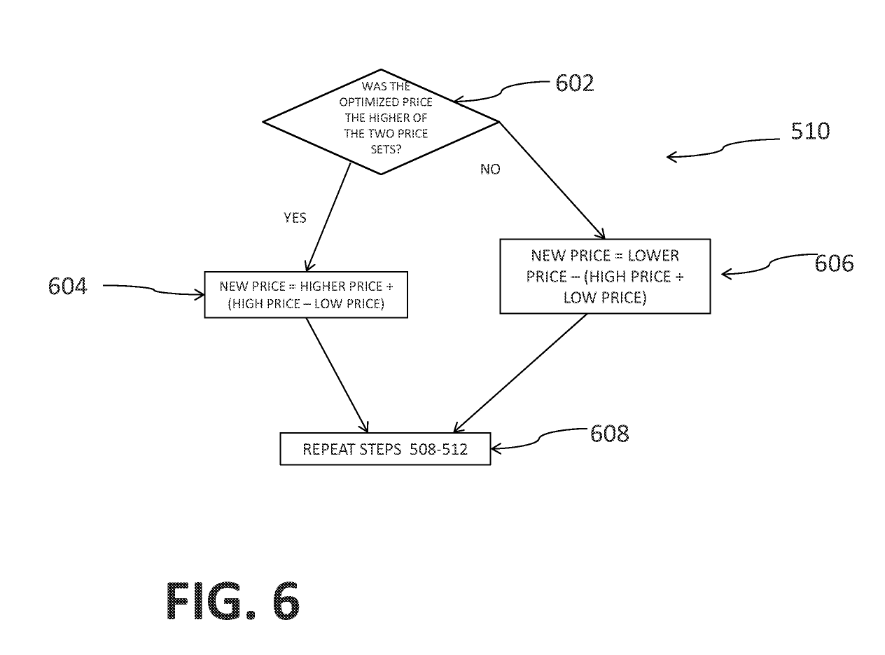

In operation 512, a new price test path is created. The new test path is calculated based on the optimized price. The new price test path calculation is further described below in FIG. 6. In operation 514, the revenue corresponding to the new price test path and the optimized price test path are compared by repeating the optimization process starting with operation 508.

FIG. 6 shows an exemplary flowchart of the method of computing a new price set. With reference to FIG. 6, in operation 602, the optimized price set is compared to the other price set and it is determined if the optimized price set is the higher price set or the lower of the two price sets.

If the optimized price was the higher price set, the process of computing a new price set continues in operation 604. In operation 604, a new price increment is calculated by subtracting the lower price set from the higher or optimized price set. The new price set is then calculated by adding the price increment to the optimized price set components and obtaining a new price set which is higher than the optimized price set. This is because in the previous optimization cycle, the optimized price set was the higher price set, and thus the optimization process continues by incrementing the price higher until a local maximum is found corresponding to a maximum price set.

If in the previous optimization cycle the optimized price set was the lower price set, then in operation 606, the new price increment is calculated by adding the previous higher price set to optimized price set. The new price set is calculated by subtracting the new price increment from the optimized price. Since the optimized price was the lower price set in the previous optimization cycle, the process continues by incrementing the previously optimized price lower with the goal of finding a local minimum price set.

The optimization process of operation 514 through 508 continues until a final optimized price is achieved.

Modules, Components, and Logic

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry or in temporarily configured circuitry (e.g., configured by software) may be driven by, for example, cost, time, energy-usage, and package size considerations.

Accordingly, the term module or engine should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

Exemplary Machine Architecture and Machine-Readable Medium

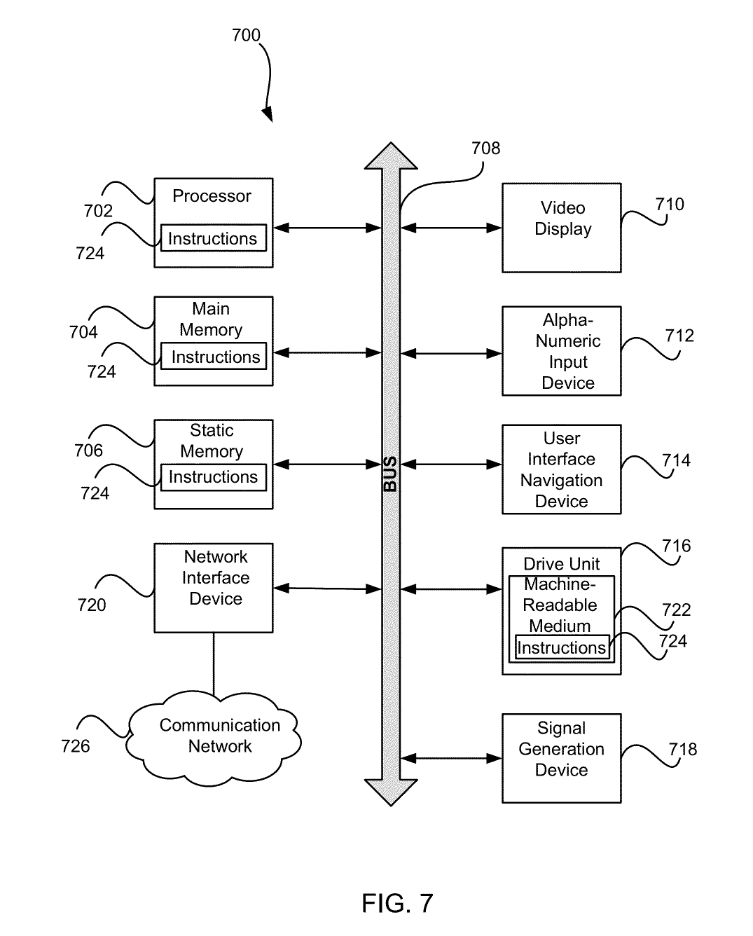

With reference to FIG. 7, an exemplary embodiment extends to a machine in the exemplary form of a computer system 700 within which instructions for causing the machine to perform any one or more of the methodologies discussed herein may be executed. In exemplary embodiments, the computer system 700 may be any one or more of the user client 106, the professional client 108, affiliate system 110, and servers of the consultation system 102. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 may include a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a Liquid Crystal Display (LCD) or a cathode tube (CRT)). In exemplary embodiments, the computer system 700 also includes one or more of an alpha-numeric input device 99 (e.g., a keyboard), a user interface (UI) navigation device or cursor control device 714 (e.g., a mouse), a disk drive unit 716, a signal generation device 718 (e.g., a speaker), and a network interface device 720.

Machine-Readable Medium

The disk drive unit 716 includes a machine-readable medium 722 on which is stored one or more sets of instructions 724 and data structures (e.g., software instructions) embodying or used by any one or more of the methodologies or functions described herein. The instructions 724 may also reside, completely or at least partially, within the main memory 704 or within the processor 702 during execution thereof by the computer system 700, the main memory 704 and the processor 702 also constituting machine-readable media.

While the machine-readable medium 722 is shown in an exemplary embodiment to be a single medium, the term “machine-readable medium” may include a single medium or multiple media (e.g., a centralized or distributed database, or associated caches and servers) that store the one or more instructions. The term “machine-readable medium” shalt also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media. Specific examples of machine-readable media include non-volatile memory, including by way of exemplary semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks. The term “machine-readable medium” shall also be taken to include any non-transitory storage medium.

Transmission Medium

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure or resource. Similarly, structures and functionality presented as a single resource may be implemented as separate resources.

These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method of optimizing prices in an online consultation website, the prices corresponding to compensation users offer to receive answers to their questions, the method using a processor to perform the steps of:
defining user attributes;
segmenting each user attribute based on parameters influencing the price;
creating at least a high price and a low price test path for each segment, wherein a high price test path corresponds to a high price set, and a low price test path corresponds to a low price set;
comparing revenue generated for each test path; and
selecting the highest revenue path as the optimized path and the price corresponding to highest revenue path as the optimized price.

2. The method of claim 1 further comprising:
selecting a new test path corresponding to a new price set;
comparing revenue generated from the optimized test path to the revenue generated from the new test path; and
selecting the test path resulting in the highest revenue as the new optimized test path; and
setting the price corresponding to the new optimized test path as the new optimized price.

3. The method of claim 2, wherein the new price is set equal to the high price plus a difference of the high price minus the low price, if the highest revenue path corresponded to the high price.

4. The method of claim 2 wherein the new price is set equal to the low price minus a sum of the high price and the low price, if the highest revenue path corresponded to the low price.

5. An apparatus for optimizing prices in an online consultation website, the prices corresponding to compensation users offer for answers to their questions, the apparatus comprising:
a price optimization module for defining user attributes;
a pricing module for segmenting each user attribute based on parameters influencing the price;
the price optimization module creates at least a high price and a low price test path for each segment, wherein a high price test path corresponds to a high price set, and a low price test path corresponds to a low price set;
the price optimization module comparing revenue generated for each test path and selecting the highest revenue path as the optimized path and the price corresponding to highest revenue path as the optimized price.

6. A non-transitory machine-readable storage medium having embodied thereon instructions which when executed by at least one processor, causes a machine to perform operations comprising:
defining user attributes;
segmenting each user attribute based on parameters influencing the price;
creating at least a high price and a low price test path for each segment, wherein a high price test path corresponds to a high price set, and a low price test path corresponds to a low price set;
comparing revenue generated for each test path; and
selecting the highest revenue path as the optimized path and the price corresponding to highest revenue path as the optimized price.
